(19) United States
(12) Patent Application Publication
(10) Pub. No.: US 2025/0155377 A1
(43) Pub. Date: May 15, 2025

(54) INSPECTION APPARATUS AND INSPECTION METHOD

(71) Applicant: TOYOTA JIDOSHA KABUSHIKI KAISHA, Toyota-shi, Aichi (JP)

(72) Inventor: Shuta NEGORO, Toyota-shi, Aichi-ken (JP)

(73) Assignee: TOYOTA JIDOSHA KABUSHIKI KAISHA, Toyota-shi, Aichi (JP)

(21) Appl. No.: 18/719,933

(22) PCT Filed: Dec. 12, 2022
(86) PCT No.: PCT/JP2022/045599

§ 371 Date: Jun. 14, 2024

(30) Foreign Application Priority Data
Dec. 24, 2021 (JP) 2021-211539

(51) Int. Cl. G01N 21/88

(52) U.S. Cl. CPC G01N 21/8851; G01N 2201/021

(57) ABSTRACT

An inspection apparatus that accurately measures a contour of a stack without destroying the stack. An inspection apparatus according to an embodiment includes a mounting base on which a stack W is mounted, a transmission plate parallel to the mounting base configured to press the stack W from above, and an imaging apparatus positioned above the transmission plate, having an optical axis substantially perpendicular to the transmission plate configured to capture an image of the stack W from above. The stack W has a structure in which a plurality of thin plates are stacked on each other, and the thin plates adjacent to each other in a stacking direction are caulked together.

### TECHNICAL FIELD

The present disclosure relates to an inspection apparatus and an inspection method for a stack.

### BACKGROUND ART

As an inspection apparatus for inspecting a stack, for example, the technique described in Patent Literature 1 is known. In Patent Literature 1, an inspection object is a laminated film structure, which is pyramidal in shape as a whole, and the laminated film structure has a layered part composed of at least two layers and the number of parts of the laminated film structure where a contour line of a layer and a contour line of a lower layer adjacent to the layer come into contact with each other is two or less. On the image data obtained by capturing an image of this object from above, at least one line segment crossing the layered part is set to determine the presence of each layer from the number of contour lines crossed by the line segment.

### CITATION LIST

### Patent Literature

Patent Literature 1: Japanese Unexamined Patent Application Publication No. H11-288463
Patent Literature 2: Japanese Unexamined Patent Application Publication No. 2016-197936

### SUMMARY OF INVENTION

### Technical Problem

A stacked iron core in which a plurality of electromagnetic steel plates are stacked on each other and the electromagnetic steel plates adjacent to each other in the stacking direction are caulked and bonded is known (see, e.g., Patent Literature 2). An image of such a stack is captured from above in the stacking direction, and the contour of the stack is inspected. At this time, the top plate is not perpendicular to the optical axis of the camera, and the captured image is distorted, and the contour may not be accurately measured.

Conventionally, one plate is peeled from the stack to form a single-layer plate, and the contour of the single-layer plate is measured to ensure the accuracy of the contour measurement. Therefore, a process for breaking the stack is required, and thus the time required for inspection increases. In addition, since this inspection is a destructive inspection, as many stacks are discarded as the number of measurements.

The present disclosure has been made in view of such a problem, and an object of the present disclosure is to provide an inspection apparatus and an inspection method capable of accurately measuring a contour of a stack without destroying the stack.

### Solution to Problem

In an aspect of the present disclosure, an inspection apparatus includes: a mounting base on which a stack is mounted; a transmission plate parallel to a mounting surface of the mounting base configured to press the stack from above; and an imaging apparatus positioned above the transmission plate and having an optical axis substantially perpendicular to the transmission plate configured to capture an image of the stack from above.

In the aspect of the present disclosure, the inspection apparatus further includes a moving mechanism configured to translate the transmission plate along the optical axis.

In the inspection apparatus according to the aspect of the present disclosure, the moving mechanism includes a guide post erected on the mounting base configured to guide the translation of the transmission plate.

In the inspection apparatus according to the aspect of the present disclosure, the moving mechanism further includes a positioning pin for regulating movement of the stack when the stack is pressed by the transmission plate.

In the inspection apparatus according to the aspect of the present disclosure, the stack has a structure in which a plurality of thin plates are stacked on each other, and the thin plates adjacent to each other in a stacking direction are caulked together.

In another aspect of the present disclosure, an inspection method includes: mounting a stack on a mounting base; pressing the stack from above using a transmission plate parallel to a mounting surface of the mounting base; and capturing an image of the stack from above using an imaging apparatus positioned above the transmission plate and having an optical axis substantially perpendicular to the transmission plate.

In the aspect of the present disclosure, the inspection method further includes translating the transmission plate along the optical axis to press the stack from above.

In the aspect of the present disclosure, the inspection method further includes guiding the translation of the transmission plate using a guide post erected on the mounting base.

In the aspect of the present disclosure, the inspection method further includes regulating movement of the stack using a positioning pin when the stack is pressed by the transmission plate.

In the inspection method according to the aspect of the present disclosure, the stack has a structure in which a plurality of thin plates are stacked on each other, and the thin plates adjacent to each other in a stacking direction are caulked together.

### Advantageous Effects of Invention

According to the present disclosure, it is possible to accurately measure a contour of a stack without destroying the stack.

### BRIEF DESCRIPTION OF DRAWINGS

FIG. 1 is a schematic diagram showing a configuration of an inspection apparatus for a stack according to an embodiment;

FIG. 2 shows the inspection apparatus of FIG. 1 viewed from an oblique upper side;

FIG. 3 is a view explaining a state in which the stack is not pressed by a transmission plate;

FIG. 4 is a view explaining a state in which the stack is pressed by a transmission plate; and

FIG. 5 is a flowchart explaining an inspection method for the stack according to the embodiment.

### DESCRIPTION OF EMBODIMENTS

Embodiments of the present disclosure will now be described with reference to the drawings. For the sake of clarity, the following descriptions and drawings have been omitted and simplified as appropriate. In each drawing, the same elements have the same reference numerals, and repeated descriptions have been omitted as necessary.

The present disclosure relates to an inspection apparatus for a stack having a structure in which a plurality of thin plates are stacked on each other and the thin plates adjacent to each other in the stacking direction are joined. The stack includes, for example, a stacked iron core in which a plurality of electromagnetic steel plates having a thickness of about 0.1 to 0.5 mm are stacked and the electromagnetic steel plates adjacent to each other in the stacking direction are joined together by caulking. The joining of the electromagnetic steel plates is not limited to caulking, but may also be joined using one or more resins, adhesives or welds.

An inspection apparatus 10 measures a contour of thin plates constituting a stack W. For example, in the case of a stacked iron core, a defect occurs in a contour when viewed in plain view due to displacement or the like that occurs when an electromagnetic steel plate is punched and formed from a sheet strip. The inspection apparatus 10 can detect a defect in the contour of the stack W and determine the quality of the stack W. In the following description, it is assumed that the stack W is rectangular in the top view.

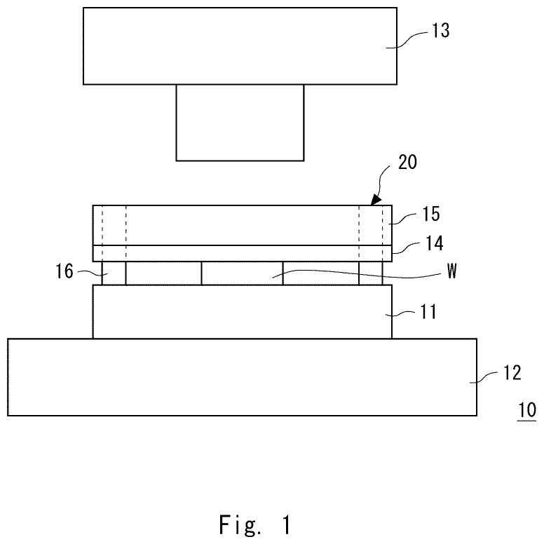

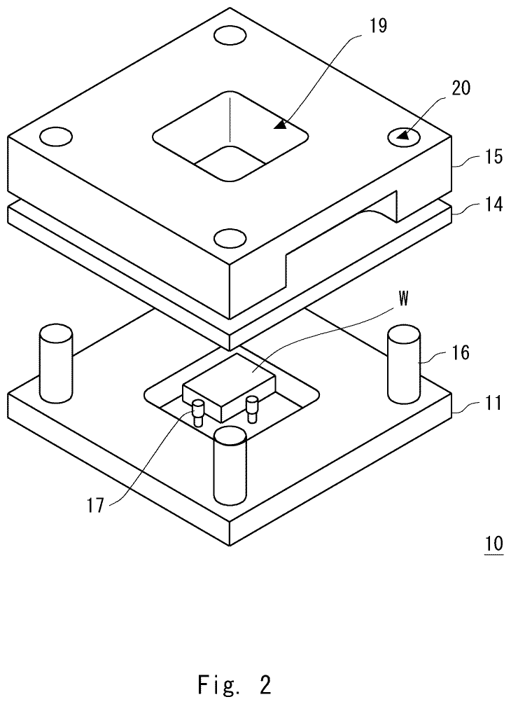

FIG. 1 is a schematic diagram showing a configuration of the inspection apparatus 10 for the stack according to the embodiment. FIG. 2 shows the inspection apparatus of FIG. 1 viewed from an oblique upper side. As shown in FIGS. 1 and 2, the inspection apparatus 10 includes a mounting base 11, an illuminating apparatus 12, an imaging apparatus 13, a transmission plate 14, a jig 15, guide posts 16, and positioning pins 17.

As shown in FIG. 2, the mounting base 11 has a recess 18 for accommodating the stack W. The bottom surface of the recess 18 serves as a support surface for supporting the stack W. The recess 18 is provided with the positioning pins 17 for positioning the stack W. The positioning pins 17 project vertically upward from the bottom surface of the recess 18. Here, two positioning pins 17 are provided, but are not limited to this.

The two positioning pins 17 abut against two adjacent side surfaces of the stack W, respectively. That is, one abutting surface and the other abutting surface on which the stack W and the positioning pins 17 abut are disposed so as to form a right angle. The positioning pins 17 regulate the movement of the stack W during inspection.

The illuminating apparatus 12 irradiates the stack W mounted on the mounting base 11 with light from below. The light irradiated from the illuminating apparatus 12 passes through the mounting base 11 and is projected onto the stack W. As the illuminating apparatus 12, for example, a light emitting diode (LED) illuminator or an organic light emitting diode (OLED) illuminator capable of surface emission is used, but the present disclosure is not limited to this.

The transmission plate 14 is disposed above the stack W mounted on the mounting base 11. The transmission plate 14 refers to a plate that allows light to pass through, and also includes a semi-transparent plate that is partially cloudy. For example, a colorless transparent parallel plate formed of glass or acrylic resin may be used as the transmission plate 14. The transmission plate 14 is attached to the jig 15 disposed above it. The jig 15 is provided with an opening 19. The inspection light passes through the opening 19 after passing through the transmission plate 14. The transmission plate 14 is parallel to the mounting surface of the mounting base 11 and presses the stack W from above.

The imaging apparatus 13 acquires image data by capturing an image of the stack W. The imaging apparatus 13 includes various image sensors or cameras such as, for example, CCDs and CMOS sensors. The imaging apparatus 13 is fixed above the transmission plate 14. That is, the transmission plate 14 and the jig 15 are disposed between the mounting base 11 and the imaging apparatus 13.

The imaging apparatus 13 can receive the inspection light that transmits through the transmission plate 14 and passes through the opening 19. The imaging apparatus 13 captures an image of the whole or a part of the stack W mounted on the lower mounting base 11 and outputs the acquired image data to an arithmetic processing apparatus (not shown). The imaging apparatus 13 may capture an image of the entire contour of the stack W in the field of view of the imaging apparatus 13 or may capture an image of only a part of the contour of the stack W.

Based on the acquired image data, the arithmetic processing apparatus may detect the contour of the stack W and perform predetermined arithmetic operations for determining the quality of the stack W. As an arithmetic processing apparatus, a computer implementing various hardware including a CPU (Central Processing Unit), a HDD (Hard Disk Drive), an SSD (Solid State Drive), a RAM (Random Access Memory), a ROM (Read Only Memory), or the like may be used. The various functions executed by the arithmetic processing apparatus may be implemented in various forms by hardware alone, software alone, or a combination thereof, and are not limited to any of them.

The imaging apparatus 13 has an optical axis substantially perpendicular to the transmission plate 14. Here, the term substantially perpendicular means that the optical axis of the imaging apparatus 13 is substantially perpendicular to the transmission plate so as to allow inevitable displacement when the optical axis is disposed perpendicular to the transmission plate. Since the transmission plate 14 is parallel to the mounting surface of the mounting base 11, the optical axis of the imaging apparatus 13 is also perpendicular to the mounting surface of the mounting base 11. The transmission plate 14 can be translated along the optical axis of the imaging apparatus 13 by a moving mechanism (not shown). The transmission plate 14 can be pressed with its lower surface in contact with the top layer of the stack W, so that the top thin plate becomes perpendicular to the optical axis of the imaging apparatus 13.

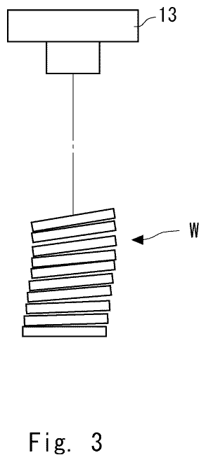

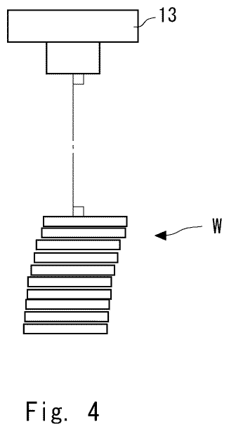

The relationship between the stack W and the imaging apparatus 13 when the stack W is pressed by the transmission plate 14 will now be described with reference to FIGS. 3 and 4. FIG. 3 is a view for explaining a state in which the stack W is not pressed by the transmission plate 14, and FIG. 4 is a view for explaining a state in which the stack W is pressed by the transmission plate 14. In FIGS. 3 and 4, the optical axis of the imaging apparatus 13 is shown by a dash-dot line. In FIGS. 3 and 4, the transmission plate 14 is not shown.

As shown in FIG. 3, when the stack W is not pressed by the transmission plate 14, the uppermost thin plate of the stack W is not perpendicular to the optical axis of the imaging apparatus 13. In this case, the captured image is distorted, and thus the contour cannot be accurately measured.

On the other hand, as shown in FIG. 4, when the stack W is pressed by the transmission plate 14, the uppermost thin plate of the stack W becomes perpendicular to the optical axis of the imaging apparatus 13. As a result, distortion of the captured image can be suppressed, and thus the contour can be accurately measured.

In the example shown in FIG. 2, guide posts 16 are erected at four corners of the mounting base 11, respectively. The guide posts 16 guide the translation of the transmission plate 14 along the optical axis of the imaging apparatus 13. The transmission plate 14 and the jig 15 are provided with four through holes 20. As shown by dashed lines in FIG. 1, the guide posts 16 are inserted into the through holes 20 of the jig 15 and the transmission plate 14, respectively.

In addition, the positioning pins 17 described above can regulate the movement of the stack W when the stack W is pressed by the transmission plate 14. Thus, the upper surface of the stack W can be easily made perpendicular to the optical axis of the imaging apparatus 13 without causing the stack W to be displaced.

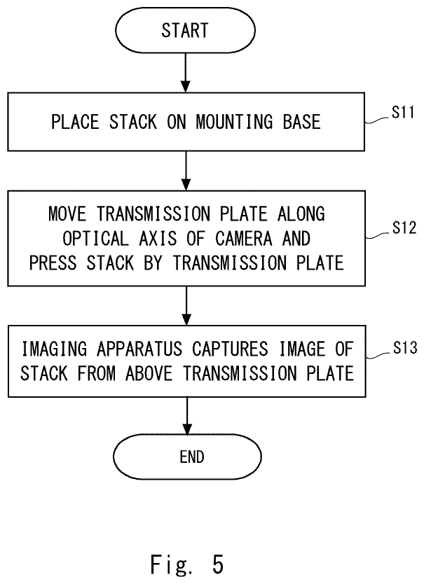

Referring now to FIG. 5, an inspection method of the stack W using the inspection apparatus 10 having the above configuration will be described. FIG. 5 is a flowchart explaining an inspection method of the stack W according to the embodiment.

As shown in FIG. 5, the stack W is first placed on the mounting base 11 (step S11). At this time, the stack W is disposed in the recess 18 so that its adjacent side surfaces abut against the positioning pins 17.

Then, the transmission plate 14 is translated along the optical axis of the imaging apparatus 13, and the stack W is pressed by the transmission plate 14 (step S12). At this time, since the stack W abuts against the positioning pins 17, it does not move when the stack W is pressed by the transmission plate 14.

After that, while the stack W is pressed by the transmission plate 14, the illuminating apparatus 12 projects light toward the stack W, and the imaging apparatus 13 captures an image of the stack W from above the transmission plate 14 (step S13). As a result, it is possible to suppress the distortion of the captured image and accurately measure the contour.

As described above, according to the embodiment, the contour of the stack W can be accurately measured without destroying the stack in which the thin plates are stacked on each other. This can reduce the temporal, personnel, and financial costs associated with the destruction or disposal of the stack W for inspection.

It should be noted that the present disclosure is not limited to the above embodiments, and can be suitably modified to the extent that it does not deviate from the purpose. In the above embodiments, the example of illumination to the stack W is shown using transillumination, but the present disclosure not limited to this, and may be, for example, epi-illumination.

This application claims the priority based on Japanese Patent Application No. 2021-211539 filed Dec. 24, 2021, disclosure of which is incorporated by reference in its entirety.

### REFERENCE SIGNS LIST

10 INSPECTION APPARATUS
11 MOUNTING BASE
12 ILLUMINATING APPARATUS
13 IMAGING APPARATUS
14 TRANSMISSION PLATE
15 JIG
16 GUIDE POST
17 POSITIONING PIN
18 RECESS
19 OPENING
20 THROUGH HOLE
W STACK

1: An inspection apparatus comprising:
a mounting base on which a stack is mounted;
a transmission plate parallel to a mounting surface of the mounting base configured to press the stack from above; and
an imaging apparatus positioned above the transmission plate and having an optical axis substantially perpendicular to the transmission plate configured to capture an image of the stack from above.

2: The inspection apparatus according to claim 1, further comprising a moving mechanism configured to translate the transmission plate along the optical axis.

3: The inspection apparatus according to claim 2, wherein the moving mechanism comprises a guide post erected on the mounting base configured to guide the translation of the transmission plate.

4: The inspection apparatus according to claim 1, further comprising a positioning pin for regulating movement of the stack when the stack is pressed by the transmission plate.

5: The inspection apparatus according to claim 1, wherein the stack has a structure in which a plurality of thin plates are stacked on each other, and the thin plates adjacent to each other in a stacking direction are caulked together.

6: An inspection method comprising:
mounting a stack on a mounting base;
pressing the stack from above using a transmission plate parallel to a mounting surface of the mounting base; and
capturing an image of the stack from above using an imaging apparatus positioned above the transmission plate and having an optical axis substantially perpendicular to the transmission plate.

7: The inspection method according to claim 6, further comprising translating the transmission plate along the optical axis to press the stack from above.

8: The inspection method according to claim 7, further comprising guiding the translation of the transmission plate using a guide post erected on the mounting base.

9: The inspection method according to claim 6, further comprising regulating movement of the stack using a positioning pin when the stack is pressed by the transmission plate.

10: The inspection method according to claim 6, wherein the stack has a structure in which a plurality of thin plates are stacked on each other, and the thin plates adjacent to each other in a stacking direction are caulked together.
